(19) United States
(12) Patent Application Publication
(10) Pub. No.: US 2008/0267758 A1
(43) Pub. Date: Oct. 30, 2008

(54) METHOD AND APPARATUS FOR PLACING STICKS

(75) Inventor: Michel ST-PIERRE, St-Prime (CA)

Correspondence Address: FASKEN MARTINEAU DUMOULIN, LLP, STOCK EXCHANGE TOWER, SUITE 3400, P.O. BOX 242, 800 PLACE VICTORIA, MONTREAL, QC, H4Z 1E9, CA

(73) Assignee: NOVILCO INC., St-Felicien (CA)

(21) Appl. No.: 12/107,447

(22) Filed: Apr. 22, 2008

Related U.S. Application Data
(60) Provisional application No. 60/914,570, filed on Apr. 27, 2007.

(51) Int. Cl. B65G 57/00

(52) U.S. Cl. 414/788.1; 414/802

(57) ABSTRACT

A stick placer is disclosed for placing a stick at a target position, the stick placer comprising a base, a vertically elongated container attached to the base for containing a plurality of sticks in a planar mat, a stick dispensing mechanism secured to the vertically elongated container for selectively dispensing a bottom stick of the plurality of sticks from the vertically elongated container, guiding means secured to the base for guiding the dispensed stick to a horizontal resting position, grasping means for grasping the stick in the horizontal resting position and moving means attached to the grasping means and to the base for selectively moving the grasping means between the horizontal resting position and the final target position.

### CROSS-REFERENCE TO RELATED APPLICATION

This nonprovisional patent application relates to and claims priority of the U.S. provisional patent application Ser. No. 60/914,570 filed Apr. 27, 2007, included herein by reference in its entirety.

### FIELD OF THE INVENTION

The invention relates to the field of stick positioning. More precisely, the invention pertains to a method and apparatus for placing sticks.

### BACKGROUND OF THE INVENTION

Stick placers are used for automatically placing sticks between stacked tiers or layers of green lumber as they are being stacked. The sticks serve, inter alia, to provide an air communication between the tiers or layers of lumber in order to allow uniform drying of the tiers or layers of lumber as well as to stabilize the tiered lumber package.

Typically, the apparatus for placing sticks is used in conjunction with a lumber stacker.

In operation, a stick placing apparatus provides one stick at a time on a horizontal surface where a layer of lumber is placed. It will be appreciated that the feeding of the stick placing apparatus may be manual or automated. Prior art sticks placing apparatus comprise a vertically disposed elongated container for containing sticks. A stick located at the bottom of the stack is collected and then provided on the horizontal surface. In one embodiment sticks are stored in a planar mat. Alternatively, the sticks may be piled each one over another one.

In the case where the sticks are stored vertically in a planar mat, it is required to rotate a given stick so that it is horizontal and it is then required to provide the rotated stick on the horizontal surface where the layer of lumber is placed.

Prior art devices for performing such tasks typically require five operations. Firstly the given stick is pushed laterally. Secondly gripping means is used to collect the given stick. Thirdly a mechanism is used for rotating the stick. Fourthly, the stick is provided on the horizontal surface where it must be placed and fifthly the gripping means releases the stick. The combination of all these operations is very cumbersome and time consuming.

It will be appreciated that there is a need for a method and apparatus that will overcome at least one above-mentioned drawback.

Features of the invention will be apparent from review of the disclosure, drawings and description of the invention below.

### BRIEF SUMMARY OF THE INVENTION

The invention provides a stick placer for placing a stick at a target position, the stick placer comprising a base, an elongated container, attached to said base, for containing a plurality of sticks in a planar mat, a stick dispensing mechanism secured to said elongated container for selectively dispensing a bottom stick of said plurality of sticks from said elongated container, guiding means secured to said base for guiding said dispensed stick to a horizontal resting position, grasping means for grasping said dispensed stick in said horizontal resting position and moving means attached to the grasping means and to the base for selectively moving the grasping means between said horizontal resting position and said final target position.

The invention further provides a method for placing a stick at a target position, the method comprising selectively providing a stick from a plurality of sticks, guiding the provided stick to a horizontal resting position and moving the stick from the horizontal resting position to the target position.

The invention further provides an apparatus for dispensing a stick from a plurality of sticks vertically stacked while simultaneously holding other sticks, the apparatus for dispensing the stick comprising a vertically elongated container for receiving the plurality of sticks vertically stacked and a rotating member located on the container for rotating between a dispensing position in which a given stick from the plurality of sticks is dispensed and a holding position in which no stick is dispensed, the rotating member comprising a finger for holding a bottom end of the plurality of sticks when the rotating member is in the holding position and a blocking member positioned such that the blocking member presses a stick immediately adjacent to the given stick against a wall of the vertically elongated container when said rotating member is in the dispensing position.

### DESCRIPTION OF THE DRAWINGS

In order that the invention may be readily understood, embodiments of the invention are illustrated by way of example in the accompanying drawings.

FIG. 1 is a schematic which shows a rear elevation view of an embodiment of a stick placer;

FIG. 2 is a schematic which shows a front elevation view of an embodiment of a stick placer;

FIG. 3 is a schematic which shows a left elevation view of an embodiment of a stick placer for placing a stick at a target position on an horizontal plane;

FIG. 4 is a schematic which shows a left elevation view of an embodiment of a stick placer wherein the bottom stick is to be dispensed using the stick dispensing mechanism;

FIG. 5 is a schematic which shows a left elevation view of an embodiment of a stick placer wherein the dispensed stick has slide on the guiding means;

FIG. 6 is a schematic which shows a left elevation view of an embodiment of a stick placer wherein the dispensed stick is grasped by the grasping means;

FIG. 7 is a schematic which shows a left elevation view of an embodiment of a stick placer wherein the moving means attached to the grasping means is moving the grasping means downwardly towards the target position;

FIG. 8 is a schematic which shows a left elevation view of an embodiment of a stick placer wherein the grasping means is positioned at the target position for the stick.

FIG. 9 is a schematic which shows a left elevation view of an embodiment of a stick placer wherein a stick is released by the grasping means at the target position on the horizontal plane;

FIG. 10 is a schematic which shows a left elevation view of an embodiment of a stick placer wherein the grasping means is positioned back at a standby position using the moving means;

FIG. 11 is a flowchart which shows one embodiment of a method for placing a stick at a target horizontal position; according to a first step a stick is provided, according to a second step, the provided stick is guided to a horizontal resting position and according to a third step, the stick is moved from the horizontal resting position to a final horizontal position; and

FIG. 12 is a flowchart which shows how the stick is moved from the horizontal resting position to the final horizontal position according to one embodiment.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

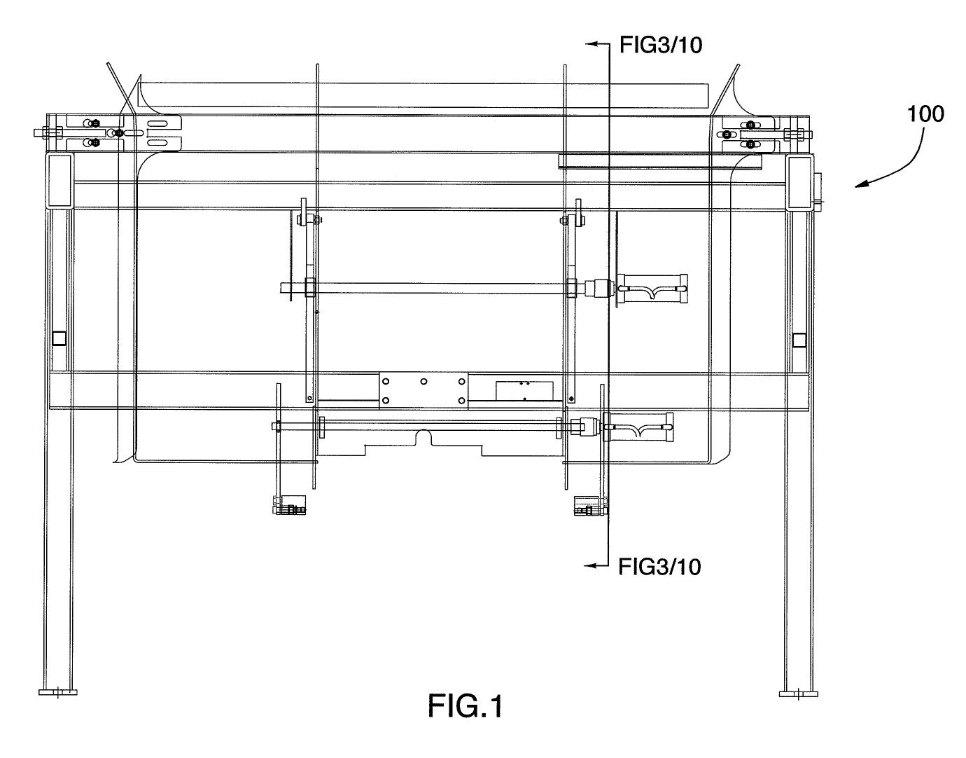

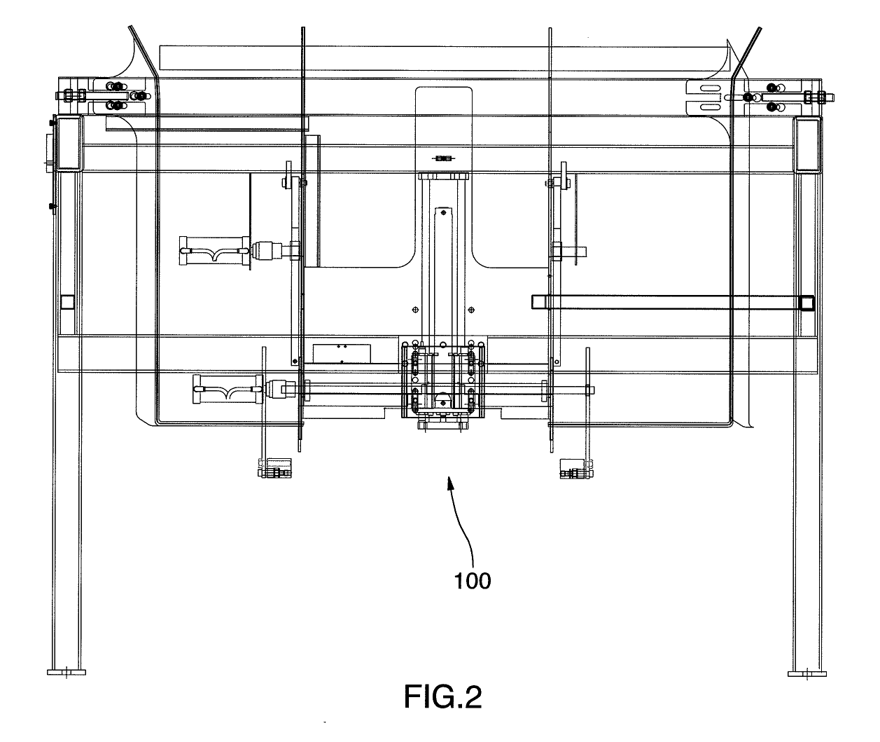

Now referring to FIG. 1 and FIG. 2, there are shown respectively a rear elevation view and a front elevation view of an embodiment of a stick placer 100.

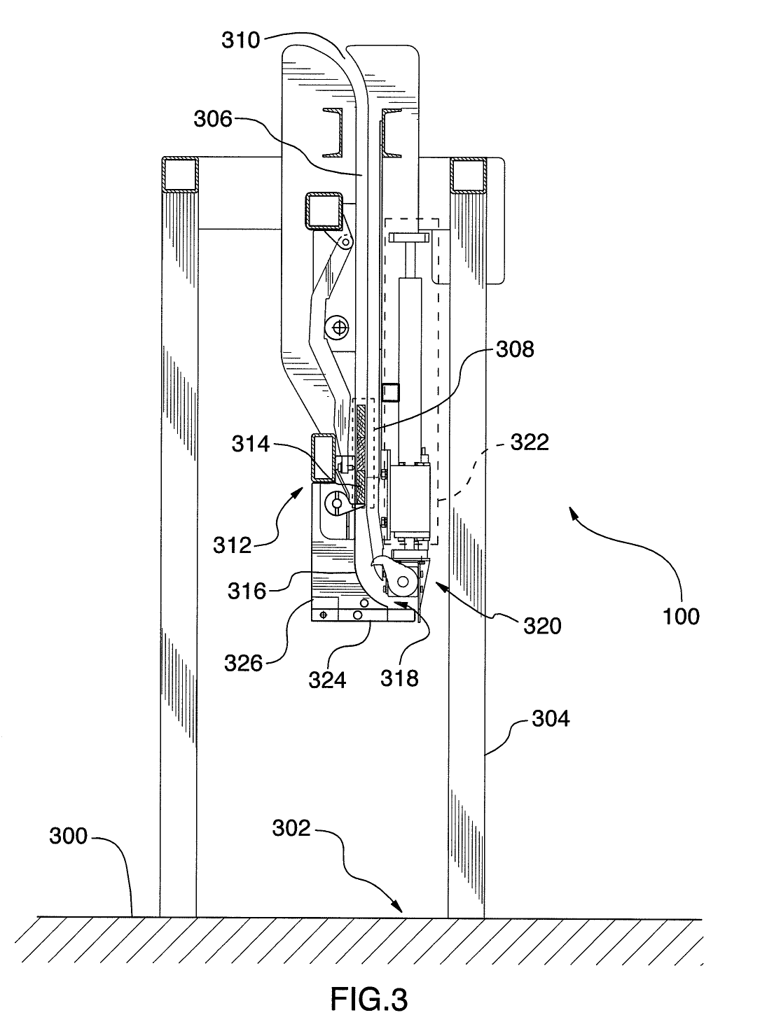

Now referring to FIG. 3, there is shown a left elevation view of an embodiment of the stick placer 100 for placing a stick at a target position 302 on a horizontal plane 300.

The stick placer 100 comprises a base, or frame, 304 and a vertically elongated container 306 attached to the base 304 for containing a plurality of sticks 308 in a planar mat.

It will be appreciated that the base 304 may be made of steel. Alternatively, the base 304 is made of aluminum.

It will be further appreciated that the vertically elongated container 306 may be defined within the base 304 in one embodiment. Still in one embodiment, the vertically elongated container 306 may be made using one of steel, aluminum and plastic. It will be appreciated that while the elongated container 306 is defined as being vertically, it should be understood by the skilled addressee that the elongated container 306 is not necessarily extending vertically and may have another shape suitable for a given application.

In the embodiment disclosed in FIG. 3, the skilled addressee will appreciate that the vertically elongated container 306 comprises a top opening 310 for receiving the plurality of sticks 308. It will be further appreciated that the plurality of sticks 308 may be provided to the vertically elongated container 306 according to various methods known to the skilled addressee.

The stick placer 100 further comprises a stick dispensing mechanism 312 operatively connected to a bottom end of the vertically elongated container 306 for selectively dispensing a bottom stick 314 of the plurality of sticks 308 from the vertically elongated container 306. It will be appreciated that the stick dispensing mechanism 312 may be secured to at least one of the base 304 and the vertically elongated container 306.

In one embodiment, the stick dispensing mechanism 312 is adapted to dispense a single stick at a time. Alternatively, the stick dispensing mechanism 312 may dispense more than one stick at a time.

The stick placer 100 further comprises guiding means 316 for guiding the dispensed stick 314 to a horizontal resting position 318. It will be appreciated that the guiding means 316 is located at a position suitable for receiving a stick dispensed by the stick dispensing mechanism 312.

It will be appreciated that the guiding means 316 may be secured to at least one of the base 304, the stick dispensing mechanism 312 and the vertically elongated container 306.

It will be appreciated that the guiding means 316 may be of various shapes to achieve such guiding. In one embodiment, the guiding means 316 has a curved shape such that a stick engaging the guiding means 316 in a vertical position exits the guiding means 316 in a horizontal position. Still in one embodiment, the guiding means 316 is made of one of steel, aluminum and plastic.

It will be appreciated by the skilled addressee that this is achieved only with the gravitation force in one embodiment, which is of great advantage since it does not require any additional energy. The skilled addressee will further appreciate that the use of the guiding means 316 advantageously enables the simultaneous performing of a translation and a rotation of the stick from a vertical position to the horizontal resting position 318 which therefore save time.

The stick placer 100 further comprises grasping means 320 for grasping the stick in the horizontal resting position 318 and moving means 322 attached to the grasping means 320 and to the base 304 for selectively moving the grasping means 320 between the horizontal resting position 318 and the final target position for the stick 302. In one embodiment, the grasping means 320 is secured on a bottom end of the moving means 322. Still in on embodiment, the top end of the moving means 322 is secured to the base 304.

It will be appreciated that the stick placer 100 further comprises an optional moveable holding support 324 for holding the stick in the horizontal resting position 318. In this embodiment, the optional moveable holding support 324 is located adjacent to the guiding means 316 such that a stick engaging the guiding means 316 will exit the guiding means 316 on the optional moveable support 324.

In one embodiment, the optional moveable holding support 324 is pivotally mounted to the guiding means 316 at a position suitable for receiving a stick exiting the guiding means 316.

In one embodiment, the optional moveable holding support 324 is made of one of steel, aluminum and plastic.

Still in the embodiment disclosed, the optional moveable holding support 324 holds the stick in the horizontal resting position 318.

Biasing means 326 may be used to keep the optional moveable holding support 324 in the horizontal position.

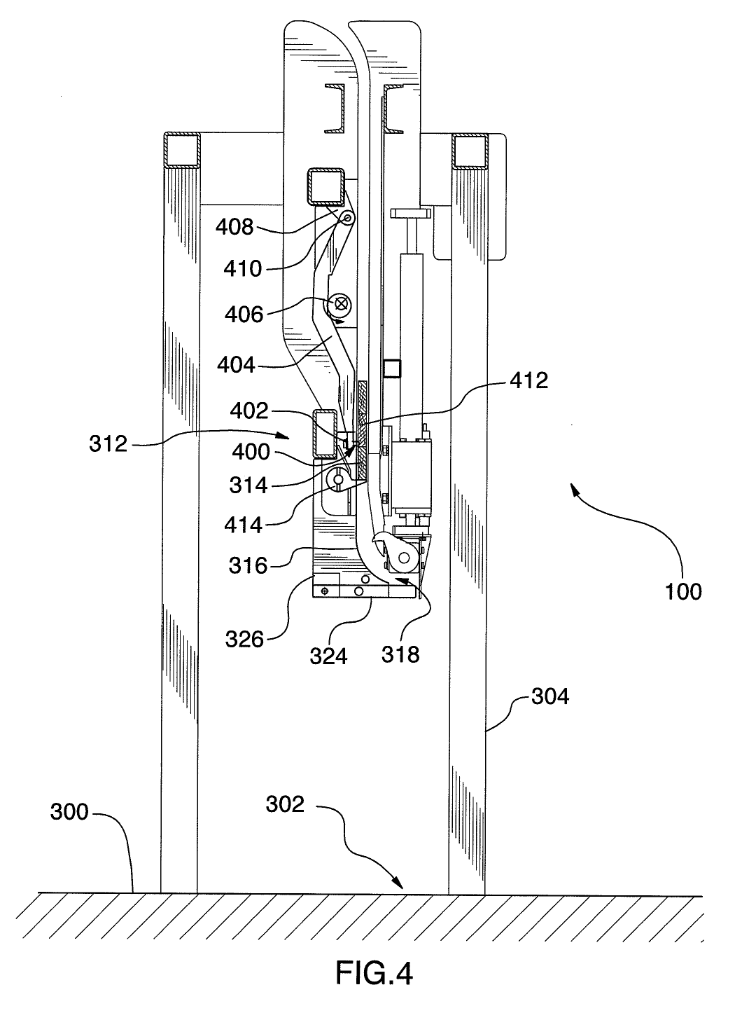

Now referring to FIG. 4, there is shown an embodiment of the stick placer 100 in which the bottom stick 314 is to be dispensed using the stick dispensing mechanism 312.

In this embodiment, the stick dispensing mechanism 312 comprises a blocking end 400, an elongated member 404, a dissymmetrical rotating member 406, a securing element 408 and a rotating holding member 414.

The blocking end 400 is secured to a first end 402 of the elongated member 404. The second end 410 of the elongated member 404 is secured to the base 304 via the securing element 408.

The dissymmetrical rotating member 406 is pivotally mounted to the base 304 and may be rotated using a rotating means such as a motor. In one embodiment, the motor comprises a rotary actuator. Alternatively, the rotating means may be selected from a group consisting of pneumatic systems (such as cylinder, air-spring bellows, etc) and electrical motors.

The rotating holding member 414 is pivotally mounted to the base 304 at a position suitable for holding the plurality of sticks 308 and is used for selectively providing a released given stick. The rotating holding member 414 may be rotated using a rotating means, such as a motor, not shown. In one embodiment, the rotating means comprises a rotary actuator. Alternatively, the rotating means may be selected from a group consisting of pneumatic systems (such as cylinder, air-spring bellows, etc) and electrical motors.

It will be appreciated that the rotating holding member 414 may operate between a dispensing position in which it does not hold the bottom stick 314 and a holding position in which it holds the bottom stick 314.

More precisely and as shown in FIG. 4, the dissymmetrical rotating member 406 is abutting the elongated member 404 such that a rotation of the dissymmetrical rotating member 406 will induce a movement in the vertical plane of the elongated member 404 either in the direction of the plurality of sticks 308 or away from the plurality of sticks 308.

Since the blocking end 400 is secured to the distal end 402 of the elongated member 404, a vertical movement of the elongated member 404 towards the plurality of sticks 308 will push the blocking end 400 against a given stick 412, in a holding position, and will therefore block the given stick 412 from moving down in the elongated container 306 by squeezing the given stick between the blocking end 400 and the wall of the elongated container 306. All the sticks located above the given stick 412 will also rest at their position when the blocking end 400 is in the holding position.

On the other end and in the case where the rotation of the dissymmetrical rotating member 406 is performed in another direction, it will be appreciated that the blocking end 400 will move away from the given stick 412 in a dispensing position. This will cause the given stick 412 to be released. In such case, any stick located above the given stick 412 will also move down until the blocking end 400 moves back in the holding position.

The skilled addressee will appreciate that by controlling the rotation of the dissymmetrical rotating member 406, it is possible to control the blocking end 400 between the holding position and the dispensing position.

Moreover, it will be appreciated that by controlling the rotation of both the dissymmetrical rotating member 406 and the rotating holding member 414 it is possible to provide an efficient stick dispensing mechanism.

The skilled addressee will further appreciate that many various other embodiments may be provided for the stick dispensing mechanism 312.

For instance, in an alternative embodiment, the stick dispensing mechanism 312 may comprise a rotating member pivotally mounted to the vertically elongated container 306. The rotating member is capable of rotating between a dispensing position in which a given stick from the plurality of sticks 308 is dispensed and a holding position in which no stick is dispensed.

Still in this embodiment, it will be appreciated by the skilled addressee that the rotating member may be actuated using various means such as electrical means, pneumatic means or the like.

More precisely, the rotating member may comprise a finger for holding the bottom end of the plurality of sticks 308 when the rotating member is in the holding position and a blocking member such that the blocking member 14 presses an immediate adjacent stick against a wall of the vertically elongated container 306 when the rotating member is in the dispensing position.

In the embodiment disclosed in FIG. 4, the stick dispensing mechanism 312 is in the holding position.

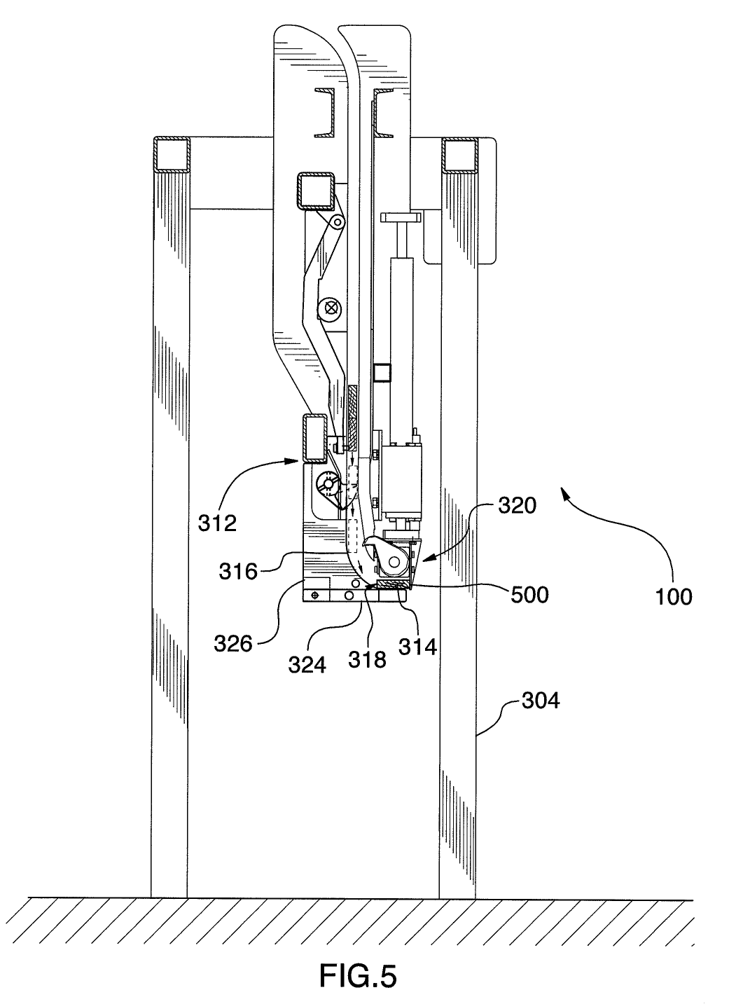

Now referring to FIG. 5, there is shown an embodiment of the stick placer 100 in which the dispensed stick 314 has slide on the guiding means 316. The skilled addressee will appreciate that the characteristics of the movement of the dispensed stick 314 may depend on various parameters such as the characteristics of the guiding means 316 and the characteristics of the dispensed stick 314.

In the embodiment disclosed, the dispensed stick 314 is supported by the moveable holding support 324 which is located adjacent to the guiding means 316 such that the dispensed stick 314 exits the guiding means 316 and arrives on the moveable holding support 324 at the horizontal resting position 318.

Moreover, it will be appreciated that in the embodiment disclosed in FIG. 5, the grasping means 320 comprises, inter alia, a stopping end 500 for stopping maintaining the dispensed stick 314 at the horizontal resting position 318.

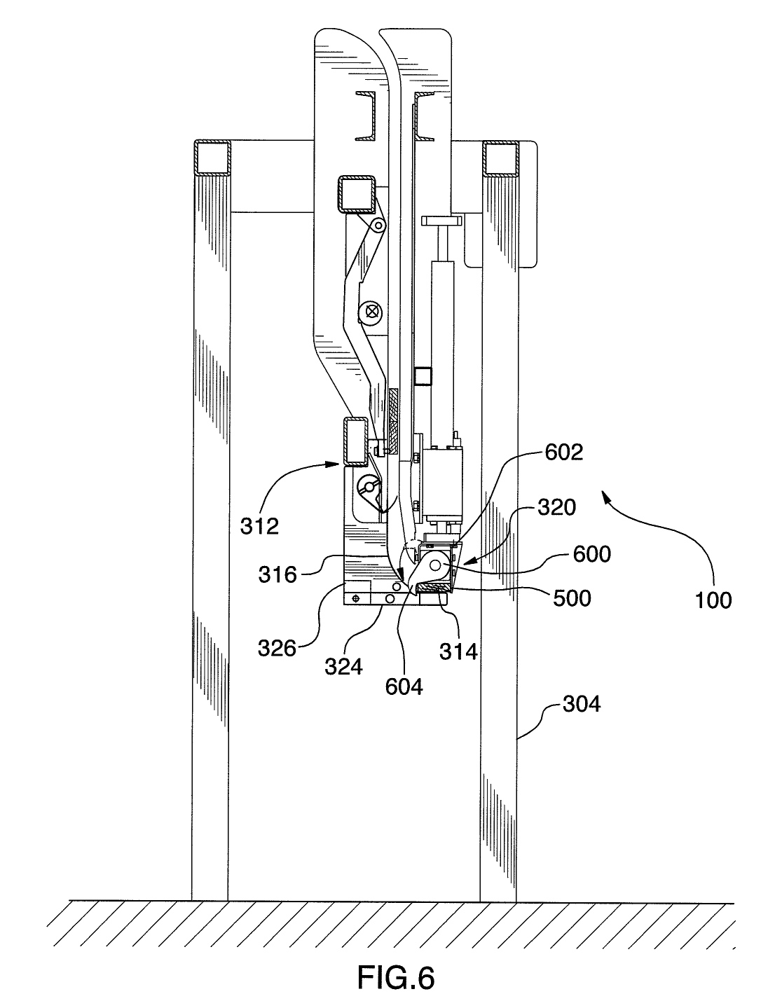

Now referring to FIG. 6, there is shown an embodiment of the stick placer 100 in which the dispensed stick 314 is grasped by the grasping means 320.

In the embodiment disclosed in FIG. 6, the grasping means 320 comprises a finger 600 pivotally mounted to a frame 602, the finger comprising a tip 604. The finger 600 may be rotated using actuating means, such as a motor, not shown. In one embodiment, the motor comprises a rotary actuator.

It will be appreciated that the finger 600 may rotate in an anti-clockwise direction against the stopping end 500 in one embodiment. Using the rotation of the finger 600, the grasping means 320 is capable of squeezing the dispensed stick 314 between the tip of the finger 604 and the stopping end 500 to thereby grasp the dispensed stick 314.

It will be appreciated that that the finger 600 may be actuated using various actuating means such as electrical means, pneumatic means or the like.

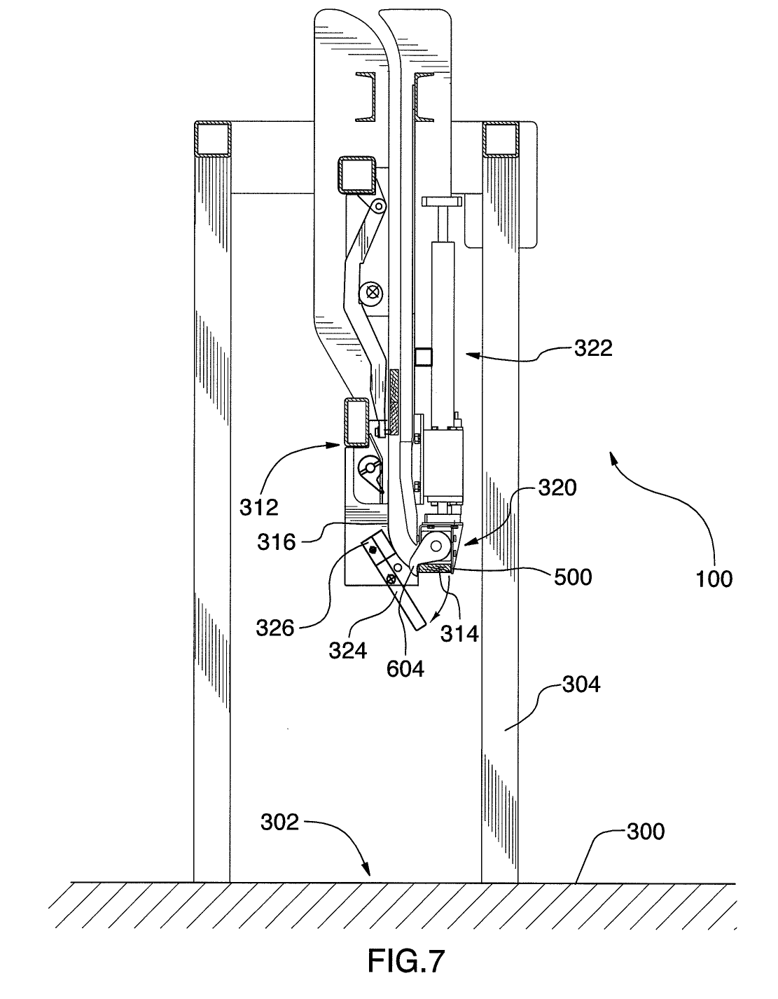

Now referring to FIG. 7, there is shown an embodiment of the stick placer 100 in which the moving means 322 attached to the grasping means 320 is moving the grasping means 320 downwardly towards the target position 302.

It will be appreciated that that the moving means 322 may be actuated using various actuating means such as electrical means, pneumatic means or the like.

The skilled addressee will appreciate that in this embodiment, the grasping means 320 is moving downwardly, pushing against the moveable holding support 324. Since the moveable holding support 324 is rotatable, the movement pushes the moveable holding support 324 into a temporary retracted position shown in FIG. 7. Due to biasing means 326, the moveable holding support 324 is capable of moving back to its original, resting, position.

In one embodiment shown in the figures, the biasing means 326 comprises a weight 700. Alternatively, the biasing means 326 comprises a spring. Alternatively, no biasing means is used and the moveable holding support 324 may be rotated using moving means which may be pneumatic, electric or the like.

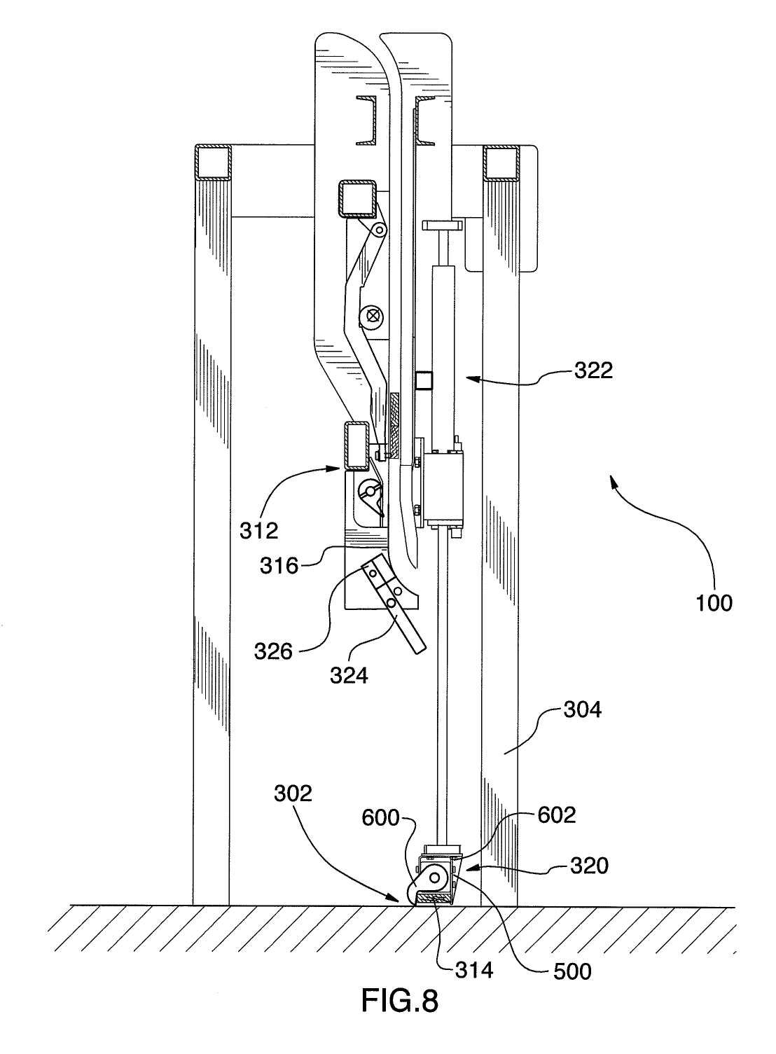

Now referring to FIG. 8, there is shown an embodiment of the stick placer 100 in which the grasping means 320 is positioned at the target position 302 for the stick.

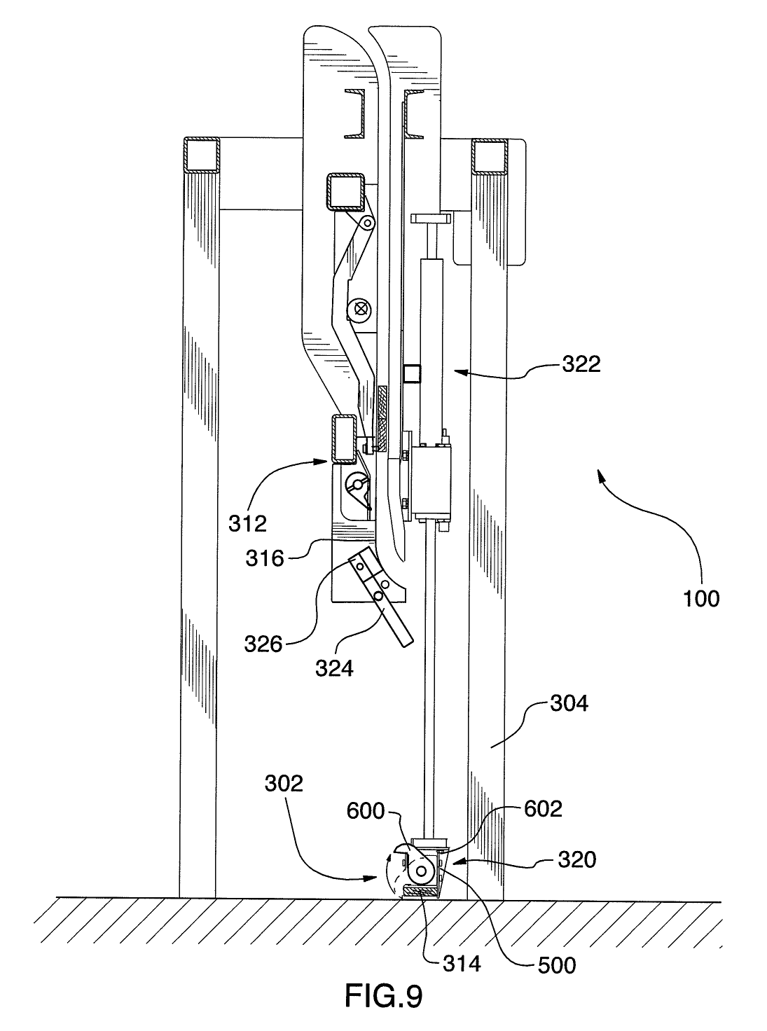

Now referring to FIG. 9, there is shown an embodiment in which the stick 314 is released by the grasping means 320 at the target position 302 on the horizontal plane 300. It will be appreciated that the stick 314 is released by the grasping means 320 by a clockwise rotation of the finger 600.

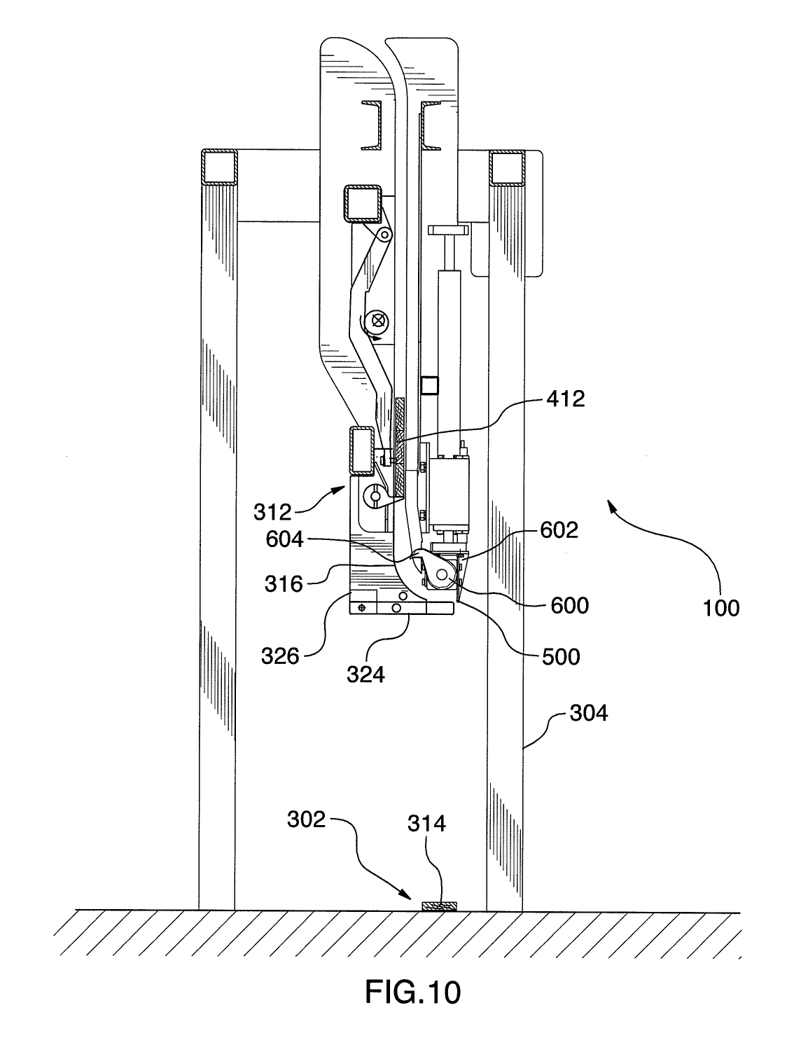

Now referring to FIG. 10, there is shown an embodiment in which the grasping means 320 is positioned back at a standby position using the moving means 322.

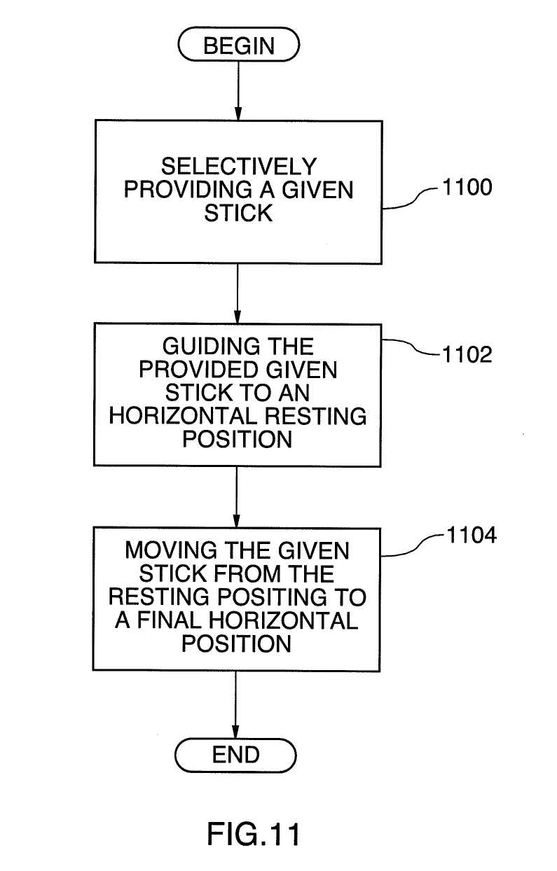

Now referring to FIG. 11, there is shown one embodiment of a method for placing a stick at a target position.

According to step 1100 a stick is selectively provided. In one embodiment, the stick is selectively provided from a vertically elongated container containing a plurality of sticks in a planar mat.

According to step 1102, the provided stick is guided to a horizontal resting position. In the preferred embodiment, the provided stick is guided to the horizontal resting position using guiding means.

According to step 1104, the stick is moved from the horizontal resting position to a final horizontal position.

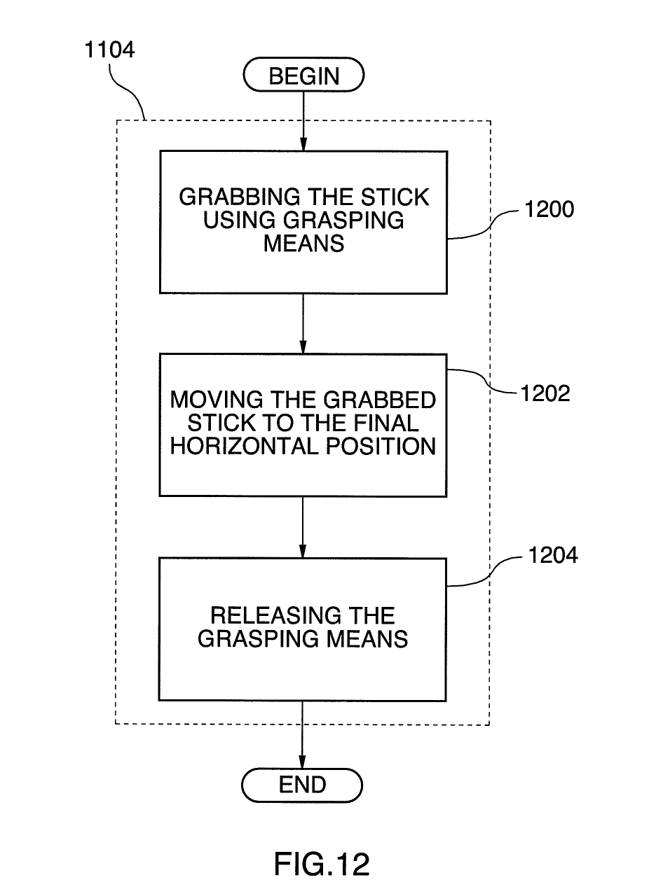

Now referring to FIG. 12, there is shown how the stick is moved from the horizontal resting position to the final horizontal position.

According to step 1200, the stick is grabbed using grasping means.

According to step 1202, the grabbed stick is moved to the final horizontal position. In one embodiment, the grabbed stick is moved in a vertical plane.

According to step 1204, the grasping means releases the stick at the final horizontal position.

It will be appreciated that in the stick placer disclosed, the sticks have a size of 1 in×3 in. The skilled addressee will appreciate that the stick placer 100 may be easily modified to accommodate various sizes and shapes of sticks.

Although the above description relates to a specific embodiment as presently contemplated by the inventor, it will be understood that the invention in its broad aspect includes mechanical and functional equivalents of the elements described herein.

I claim:

1. A stick placer for placing a stick at a target position, the stick placer comprising:
a base,
an elongated container, attached to said base, for containing a plurality of sticks in a planar mat;
a stick dispensing mechanism secured to said elongated container for selectively dispensing a bottom stick of said plurality of sticks from said elongated container;
guiding means secured to said base for guiding said dispensed stick to a horizontal resting position;
grasping means for grasping said dispensed stick in said horizontal resting position; and
moving means attached to the grasping means and to the base for selectively moving the grasping means between said horizontal resting position and said final target position.

2. The stick placer as claimed in claim 1, wherein said elongated container is a vertically elongated container.

3. The stick placer as claimed in claim 1, wherein said stick dispensing mechanism is operatively connected to a bottom end of the elongated container.

4. The stick placer as claimed in claim 3, wherein said stick dispensing mechanism comprises an elongated member having a first end and a second end secured to the base, a blocking end secured to the first end of the elongated member, a dissymmetrical rotating member abutting the elongated member such that a rotation of the dissymmetrical rotating member will create a movement of the blocking end between one of a holding position and a releasing position in which a given stick is released, further wherein said stick dispensing mechanism comprises a rotating holding member for selectively providing the given stick when the released given stick is released from the blocking end.

5. The stick placer as claimed in claim 1, further comprising a moveable holding support pivotally mounted to the guiding means, said moveable holding support holding a stick in the horizontal resting position and rotating between the horizontal resting position and a temporary retracted position.

6. The stick placer as claimed in claim 5, wherein said moveable holding support comprises biasing means for moving the moveable holding support back in the resting position.

7. The stick placer as claimed in claim 6, wherein said biasing means comprises at least one of a weight and a spring.

8. The stick placer as claimed in claim 6, wherein said moveable holding support is rotated using one of pneumatic rotating means and electric rotating means.

9. The stick placer as claimed in claim 3, wherein said stick dispensing mechanism comprises a rotating member pivotally mounted to the elongated container and rotating between one of a dispensing position and a holding position, said rotating member comprising a finger for holding a bottom end of a given stick to dispense of the plurality of sticks and a blocking member for blocking an adjacent stick to the given stick when said given stick to dispense is released.

10. The stick placer as claimed in claim 9, wherein said rotating member is actuated using actuating means selected from a group consisting of electric means and pneumatic means.

11. The stick placer as claimed in claim 1, wherein said grasping means comprises a frame, a stopping end mounted on the frame and a finger pivotally mounted to the frame.

12. The stick placer as claimed in claim 11, wherein said finger is actuated using actuating means selected from a group consisting of electrical means and pneumatic means.

13. The stick placer as claimed in claim 1, wherein said moving means is actuated using actuating means selected from a group consisting of electrical means and pneumatic means.

14. The stick placer as claimed in claim 1, wherein said moving means is moving the grasping means between said horizontal resting position and said final target position in a vertical plane.

15. A method for placing a stick at a target position, the method comprising:
selectively providing a stick from a plurality of sticks;
guiding the provided stick to a horizontal resting position; and
moving the stick from the horizontal resting position to the target position.

16. The method as claimed in claim 15, wherein said moving of said stick from the horizontal resting position to the target position comprises grabbing the stick in the horizontal resting position using grasping means, moving the gasping means to the target position and the grasping means releasing the stick.

17. The method as claimed in claim 16, wherein said grasping means is moved in a vertical plane.

18. The stick placer as claimed in claim 1, wherein said plurality of sticks comprises a wood stick.

19. An apparatus for dispensing a stick from a plurality of sticks vertically stacked while simultaneously holding the other sticks, the apparatus for dispensing the stick comprising:
a vertically elongated container for receiving said plurality of sticks vertically stacked; and
a rotating member located on said container for rotating between a dispensing position in which a given stick from said plurality of sticks is dispensed and a holding position in which no sticks is dispensed, said rotating member comprising a finger for holding the bottom end of said plurality of sticks when said rotating member is in the holding position and a blocking member such that the blocking member presses an adjacent stick against a wall of said vertically elongated container when said rotating member is in said dispensing position.
